(19) United States
(12) Patent Application Publication
(10) Pub. No.: US 2014/0347015 A1
(43) Pub. Date: Nov. 27, 2014

(54) POWER SUPPLY AVOIDING OVER-DISCHARGE OF BATTERY MODULES

(71) Applicant: ZIPPY TECHNOLOGY CORP., New Taipei City (TW)

(72) Inventors: Tsun-Te SHIH, New Taipei City (TW); Yu-Yuan CHANG, New Taipei City (TW); Kuang-Lung SHIH, New Taipei City (TW); Po-Wen HSIAO, New Taipei City (TW)

(73) Assignee: ZIPPY TECHNOLOGY CORP., New Taipei City (TW)

(21) Appl. No.: 13/898,945

(22) Filed: May 21, 2013

(51) Int. Cl. H02J 7/00; H02J 9/06

(52) U.S. Cl. CPC H02J 7/0031; H02J 9/061
USPC 320/136

(57) ABSTRACT

A power supply avoiding over-discharge of battery modules includes a main power supply system and a redundant power supply system. The invention uses a battery protection module to detect the status of a battery module in the redundant power supply system in normal conditions. The battery protection module includes an activation path connected to the main power supply system to receive standby power, a battery detection path connected to the battery module to receive a micro current and generate a protection activation signal when the battery module is in a charge-waiting state, and a protection activation path connected to a switch unit in the redundant power supply system to receive the protection activation signal to make the switch unit enter an OFF state.

### FIELD OF THE INVENTION

The present invention elates to a power supply and particularly to a power supply that uses a battery protection module to prevent over-discharge of battery modules.

### BACKGROUND OF THE INVENTION

Modern large-scale information equipment such as servers or databases generally is equipped with a redundant power supply to provide steady power for prolonged operation. A conventional redundant power supply such as one disclosed in U.S. Pat. No. 7,495,415 includes a main power supply module and a redundant power module. In normal conditions, the main power supply module receives and converts an external power and outputs a working power. The redundant power module generally is a battery or capacitor to receive the working power and save as a redundant power.

In the event that the main power supply module cannot get the external power normally and normally supply the working power, the potential of the working power is lower than that of the redundant power so that the redundant power module immediately outputs the redundant power to make the main power supply module continuously supply the working power for a selected duration. However, the amount of the redundant power stored in the redundant power module is determined by the capacity thereof. In other words, as soon as the oxidation-reduction reaction of the redundant power module reaches a balanced state, the redundant power is exhausted. In such an occasion, although the redundant power module cannot supply the redundant power, it still can be connected with other related circuits to output a micro current, then enters a deep discharge state. But the deep discharge phenomenon is harmful to the redundant power module and could shorten its lifespan.

Although the present redundant power supply generally has a redundant power detection module to monitor power saving or output status of the redundant power in normal condition, the redundant power detection module generally detects merely discharge currents with greater amperes because of its circuit design and detection sampling, but regards the micro current output from the redundant power module in the deep discharge state as noises. Hence the redundant power detection module cannot prevent the redundant power module from entering the deep discharge state. This causes a shortened lifespan of the redundant power module.

### SUMMARY OF THE INVENTION

The primary object of the present invention is to solve the problem of the conventional power supply that cannot avoid battery modules from entering a deep discharge state to result in a shorter lifespan thereof.

To achieve the foregoing object, the invention provides a power supply that can prevent over-discharge of battery modules. The power supply comprises a main power supply system, a redundant power supply system, a power supply switch module and a battery protection module. The main power supply system is connected to an external power source to convert and output at least one working power and a standby power. The redundant power supply system is connected to the main power supply system to receive the working power, and includes a battery module and a switch unit which is connected to the battery module and has an ON state and an OFF state. When the switch unit is in the ON state, the battery module has a charging state to be charged by the working power and saves as a redundant power, a discharging state to output the redundant power, and a charge-waiting state to stop outputting the redundant power but output a micro current when the redundant power is discharged for a selected duration and oxidation-reduction reaction of the battery module reaches a balanced state. Alternatively, when the switch unit is in the OFF state, the battery module enters a shutdown state by not receiving the working power and the redundant power. The power supply switch module is connected to the main power supply system and redundant power supply system to receive the working power, standby power and redundant power, and includes a first power supply state in which the working power is higher than the redundant power so that the working power is output, and a second power supply state in which the working power is lower than the redundant power so that the redundant power is output. The battery protection module includes an activation path connected to the main power supply system to receive the standby power, a battery detection path connected to the battery module to receive the micro current and generate a protection activation signal when the battery module is in the charge-waiting state, and a protection activation path connected to the switch unit to receive the protection activation signal to make the switch unit enter the OFF state.

In one embodiment the main power supply system includes a rectification filter unit connected to the external power source, a power factor correction unit connected to the rectification filter unit, a transformer, a pulse width control unit and a switch element.

In another embodiment the power supply further includes a power regulation module connected to the power supply switch module to receive the working power, standby power and redundant power and convert the working power or redundant power.

In yet another embodiment the battery protection module is a microcontroller.

In yet another embodiment the main power supply system includes a charge control unit connected to the switch unit to charge the battery module by the working power when the switch unit is in the ON state and the battery module is in the charging state.

In yet another embodiment the redundant power supply system includes a charge control unit connected to the switch unit to charge the battery module by the working power when the switch unit is in the ON state and the battery module is in the charging state.

Compared with the conventional power supply, the invention uses the battery protection module to receive the micro current from the battery module in the charge-waiting state and generate a protection activation signal to make the battery module enter the shutdown state, thereby resolves the problem that a redundant power detection module in the conventional power supply regards the micro current as noises or does not detect to cause over-discharge of the battery module and shorten the lifespan thereof.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic block diagram of an embodiment of the power supply avoiding over-discharge of battery modules according to the invention.

FIG. 2 is a schematic block diagram of another embodiment of the power supply avoiding over-discharge of battery modules according to the invention.

### DETAILED DESCRIPTION OF THE PREFERRED EMBODIMENTS

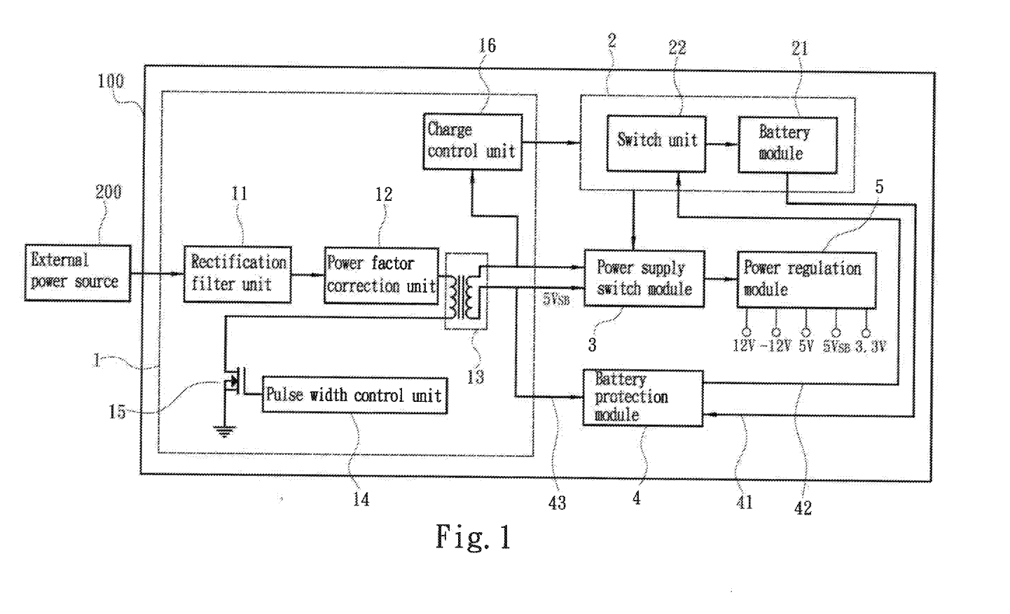

Please refer to FIG. 1, the present invention aims to provide a power supply that can avoid over-discharge of battery modules and supply a redundant power to maintain continuous operation thereof p for a selected duration when an external power source 200 cannot supply power normally. The power supply 100 can be a redundant power supply that comprises a main power supply system 1, a redundant power supply system 2, a power supply switch module 3 and a battery protection module 4. The main power supply system 1 is connected to an external power source 200 to receive an external power and convert and output at least one working power and a standby power. More specifically, the main power supply system 1 includes a rectification filter unit 11 connected to the external power source 200, a power factor correction unit 12 connected to the rectification filter unit 11, a transformer 13, a pulse width control unit 14 and a switch element 15. The external power is rectified and filtered by the rectification filter unit 11. After the external power is output to the power factor correction unit 12, its power factor is regulated by a voltage regulation level. The pulse width control unit 14 outputs a driving signal to determine the duty cycle of the switch element 15. Through the periodical ON and OFF of the switch element 15, coil current of the transformer 13 is regulated, and the working power and standby power are output.

On the other hand, the redundant power supply system 2 is connected to the main power supply system 1 to receive the working power, and includes a battery module 21 and a switch unit 22 connected to the battery module 21 and having an ON state and an OFF state. The switch unit 22 can be an electronic switch. When the switch unit 22 is in the ON state, the battery module 21 has a charging state to be charged by the working power and save as a redundant power, a discharging state to output the redundant power, and a charge-waiting state to stop outputting the redundant power but output the micro current when the redundant power is discharged in the discharging state for a selected duration and the oxidation-reduction reaction of the battery module 21 reaches a balanced state. When the switch unit 22 is in the OFF state, the battery module 21 enters a shutdown state by not receiving the working power and the redundant power. The power supply switch module 3 is connected to the main power supply system 1 and redundant power supply system 2 to receive the working power, standby power and redundant power, and has a first power supply state in which the working power is higher than the redundant power so that the working power is output, and a second power supply state in which the working power is lower than the redundant power so that the redundant power is output. In addition, the battery protection module 4 includes an activation path 43 connected to the main power supply system 1 to receive the standby power, a battery detection path 41 connected to the battery module 21 to receive the micro current and generate a protection activation signal when the battery module 21 is in the charge-waiting state, and a protection activation path 42 connected to the switch unit 22 to receive the protection activation signal to make the switch unit 22 enter the OFF state. Moreover, the battery protection module 4 can be a microcontroller.

Furthermore, the power supply 100 further includes a power regulation module 5 connected to the power supply switch module 3 to receive the working power, standby power and redundant power, and convert the working power or redundant power. More specifically, the general information equipment adopts ATX power supply specification which outputs the working power at different potentials of 12V, −12V, 5V and 13V and the standby power of 5VSB. After the power regulation module 5 has received the working power or redundant power, it regulates the working power at different potentials for output under the ATX specification.

More specifically, while the power supply 100 is activated, the main power supply system 1 receives the external power and converts and outputs the working power and standby power. The switch unit 22 also is triggered to enter the ON state, so that the battery module 21 receives the working power through the switch unit 22 and enters the charging state to save the working power as the redundant power. After a period of time, in the event that the power supply 100 cannot get the external power and output the working power normally, the power supply switch module 3 determines that the working power is lower than the redundant power and outputs the redundant power; namely, the battery module 21 enters the discharging state to allow the switch unit 22 to output the redundant power to the power supply switch module 3. After the battery module 21 has discharged for a selected duration, the oxidation-reduction reaction of the battery module 21 reaches a balanced state, thereby output of the redundant power is stopped and the battery module 21 is switched from the discharging state to the charge-waiting state. In the charge-waiting state, although the redundant power cannot be output normally, the battery module 21 still can output the micro current as it is connected to other related circuits. When the battery detection path 41 receives the micro current, it immediately generates the protection activation signal which passes through the protection activation path 42 to make the switch unit 22 enter the OFF state and make the battery module 21 switch to the shutdown state from the charge-waiting state. Hence over-discharge of the battery module 21 can be avoided and the lifespan of the battery module 21 can be prolonged. Moreover, the battery protection module 4 is activated by receiving the standby power, so that the battery protection module 4 can perform detection in normal conditions.

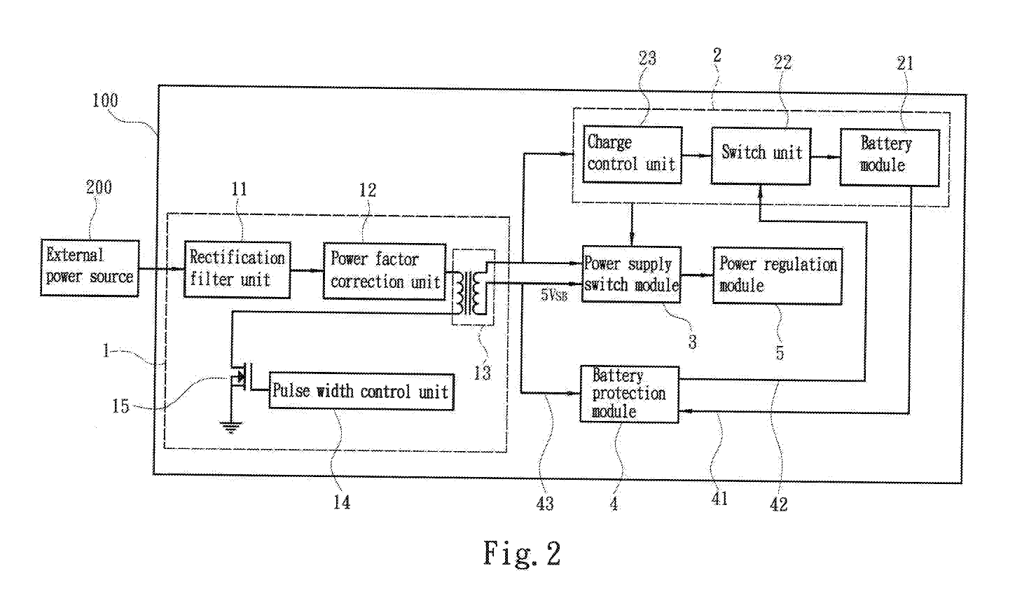

Please refer to FIG. 1 again. The invention can further include a charge control unit in the main power supply system 1 or redundant power supply system 2. If the charge control unit is installed in the main power supply system 1, the charge control unit 16 is connected to the switch unit 22 and receives the working power to charge the battery module 21 when the switch unit 22 is in the ON state and the battery module 21 is in the charging state. Please refer to FIG. 2. If the charge control unit is installed in the redundant power supply system 2, the charge control unit 23 also is connected to the switch unit 22 and gets the working power from the main power supply system 1 to charge the battery module 21 when the switch unit 22 is in the ON state and the battery module 21 is in the charging state.

As a conclusion, the present invention provides a power supply that can avoid over-discharge of battery modules and includes a main power supply system and a redundant power supply system. It uses a battery protection module to detect the state of the battery module in the redundant power supply system in normal conditions. The battery protection module includes an activation path connected to the main power supply system to receive the standby power, a battery detection path connected to the battery module to receive the micro current and generate a protection activation signal while the battery module is in the charge-waiting state, and a protection activation path connected to a switch unit in the redundant power supply system to receive the protection activation signal to make the switch unit enter an OFF state. Thus over-discharge of the battery module can be avoided without shortening the lifespan thereof.

What is claimed is:

1. A power supply avoiding over-discharge of battery modules, comprising:
a main power supply system connected to an external power source to convert and output at least one working power and a standby power;
a redundant power supply system which is connected to the main power supply system to receive the working power and includes a battery module and a switch unit connected to the battery module and having an ON state and an OFF state; in the ON state of the switch unit, the battery module including a charging state to be charged by the working power and save as a redundant power, a discharging state to output the redundant power and a charge-waiting state to stop outputting the redundant power but output a micro current while the redundant power is discharged in the discharging state for a selected duration and oxidation-reduction reaction of the battery module reaches a balanced condition; in the OFF state of the switch unit, the battery module entering a shutdown state by not receiving the working power and outputting the redundant power;
a power supply switch module which is connected to the main power supply system and the redundant power supply system to receive the working power, the standby power and the redundant power, and includes a first power supply state in which the working power is higher than the redundant power so that the working power is output, and a second power supply state in which the working power is lower than the redundant power so that the redundant power is output; and
a battery protection module which includes an activation path connected to the main power supply system to receive the standby power, a battery detection path connected to the battery module to receive the micro current and generate a protection activation signal when the battery module is in the charge-waiting state, and a protection activation path connected to the switch unit to receive the protection activation signal to make the switch unit enter the OFF state.

2. The power supply of claim 1, wherein the main power supply system includes a rectification filter unit connected to the external power source, a power factor correction unit connected to the rectification filter unit, a transformer, a pulse width control unit and a switch element.

3. The power supply of claim 1 further including a power regulation module connected to the power supply switch module to receive the working power, the standby power and the redundant power, and convert the working power or the redundant power.

4. The power supply of claim 1, wherein the battery protection module is a microcontroller.

5. The power supply of claim 1, wherein the main power supply system includes a charge control unit connected to the switch unit to charge the battery module by the working power when the switch unit is in the ON state and the battery module is in the charging state.

6. The power supply of claim 1, wherein the redundant power supply system includes a charge control unit connected to the switch unit to charge the battery module by the working power when the switch unit is in the ON state and the battery module is in the charging state.
